(19) United States
(12) Patent Application Publication
(10) Pub. No.: US 2025/0045754 A1
(43) Pub. Date: Feb. 6, 2025

(54) SYSTEMS AND METHODS FOR CONVERSATIONAL TRANSACTING

(71) Applicant: JPMORGAN CHASE BANK, N.A., New York, NY (US)

(72) Inventors: Howard SPECTOR, Street, MD (US); Emi ALEXANDER, New Canaan, CT (US); Louis CULOT, Brooklyn, NY (US); Edward OLEBE, New Paltz, NY (US); Sridhar ARAVAMUDHAN, Middletown, DE (US)

(21) Appl. No.: 18/792,410

(22) Filed: Aug. 1, 2024

Related U.S. Application Data
(60) Provisional application No. 63/517,738, filed on Aug. 4, 2023.

(51) Int. Cl. G06Q 20/40

(52) U.S. Cl. CPC G06Q 20/4012; G06Q 20/4015; G06Q 20/405

(57) ABSTRACT

Systems and methods for conversational transacting are disclosed. In one embodiment, a method may include: (1) receiving, by a merchant computer program, a payment instrument from a customer; (2) initiating, by the merchant computer program, a session with the customer by providing a session identifier for the session to a customer electronic device; (3) during the session: receiving, by the merchant computer program, a plurality of transactions from the customer, each with the session identifier; and authorizing, by the merchant computer program, each of the plurality of transactions with an issuer of the payment instrument; and (4) at an end of the session: aggregating, by the merchant computer program, the transactions that were authorized by the issuer; and submitting, by the merchant computer program, the aggregated transactions to the issuer for payment.

### RELATED APPLICATIONS

This application claims priority to, and the benefit of, U.S. Provisional Patent Application Ser. No. 63/517,738, filed Aug. 4, 2023, the disclosure of which is hereby incorporated, by reference, in its entirety.

### BACKGROUND OF THE INVENTION

### 1. Field of the Invention

Embodiments are generally directed to systems and methods for conversational transacting.

### 2. Description of the Related Art

Individual transactions are generally conducted as a series of individual transactions. For example, a customer may purchase an item in one transaction, and if the customer returns to purchase a second item, a second transaction is required.

### SUMMARY OF THE INVENTION

Systems and methods for conversational transacting are disclosed. In one embodiment, a method may include: (1) receiving, by a merchant computer program, a payment instrument from a customer; (2) initiating, by the merchant computer program, a session with the customer by providing a session identifier for the session to a customer electronic device; (3) during the session: receiving, by the merchant computer program, a plurality of transactions from the customer, each with the session identifier; and authorizing, by the merchant computer program, each of the plurality of transactions with an issuer of the payment instrument; and (4) at an end of the session: aggregating, by the merchant computer program, the transactions that were authorized by the issuer; and submitting, by the merchant computer program, the aggregated transactions to the issuer for payment.

In one embodiment, the method may also include: receiving, by the merchant computer program, a customer PIN with the payment instrument. The merchant computer program authorizes one of the transactions with the issuer of the payment instrument using the customer PIN.

In one embodiment, the method may also include: receiving, by the merchant computer program, a transaction limit from the customer; and applying, by the merchant computer program, the transaction limit to each transaction before authorizing the transaction with the issuer. The transaction limit may be a maximum number of transactions during the session, a maximum dollar amount for each transaction during the session, a maximum total dollar amount for all transactions during the session, etc.

In one embodiment, the method may also include: receiving, by the merchant computer program, a session duration from the customer, and sending, by the merchant computer program, the session at completion of the session duration.

In one embodiment, the method may also include: receiving, by the merchant computer program, rules from the issuer; and applying, by the merchant computer program, the rules to each transaction before authorizing each transaction with the issuer.

In one embodiment, the method may also include: periodically receiving, by the merchant computer program, a location of the customer electronic device; and ending, by the merchant computer program, the session in response to the location of the customer electronic device being outside of a merchant location.

According to another embodiment, a non-transitory computer readable storage medium, including instructions stored thereon, which when read and executed by one or more computer processors, cause the one or more computer processors to perform steps comprising: receiving a payment instrument from a customer; initiating a session with the customer by providing a session identifier for the session to a customer electronic device; during the session: receiving a plurality of transactions from the customer, each with the session identifier; and authorizing each of the plurality of transactions with an issuer of the payment instrument; and at an end of the session: aggregating the transactions that were authorized by the issuer; and submitting the aggregated transactions to the issuer for payment.

In one embodiment, the non-transitory computer readable storage medium may also include instructions stored thereon, which when read and executed by the one or more computer processors, cause the one or more computer processors to perform steps comprising: receiving a customer PIN with the payment instrument; and authorizing one of the transactions with the issuer of the payment instrument using the customer PIN.

In one embodiment, the non-transitory computer readable storage medium may also include instructions stored thereon, which when read and executed by the one or more computer processors, cause the one or more computer processors to perform steps comprising: receiving a transaction limit from the customer; and applying the transaction limit to each transaction before authorizing the transaction with the issuer. In one embodiment, the transaction limit may be a maximum number of transactions during the session, a maximum dollar amount for each transaction during the session, a maximum total dollar amount for all transactions during the session, etc.

In one embodiment, the non-transitory computer readable storage medium may also include instructions stored thereon, which when read and executed by the one or more computer processors, cause the one or more computer processors to perform steps comprising: receiving a session duration from the customer, and ending the session at a completion of the session duration.

In one embodiment, the non-transitory computer readable storage medium may also include instructions stored thereon, which when read and executed by the one or more computer processors, cause the one or more computer processors to perform steps comprising: receiving rules from the issuer; and applying the rules to each transaction before authorizing the transaction with the issuer.

In one embodiment, the non-transitory computer readable storage medium may also include instructions stored thereon, which when read and executed by the one or more computer processors, cause the one or more computer processors to perform steps comprising: periodically receiving a location of the customer electronic device; and ending the session in response to the location of the customer electronic device being outside of a merchant location.

According to another embodiment, a system may include: a customer electronic device associated with a customer; a merchant system executing a merchant computer program; and an issuer electronic device executing an issuer computer program. The merchant computer program may be configured to receive a payment instrument from the customer; to initiate a session with the customer by providing a session identifier for the session to the customer electronic device; to receive rules from the issuer computer program. During the session, the merchant computer program may be configured to receive a plurality of transactions from the customer, each with the session identifier; to apply the rules to each of the plurality of transactions; to authorize each of the plurality of transactions with the issuer computer program in response to the transaction passing the rules; and the issuer computer program may be configured to authorize each of the transactions and to return an authorization decision to the merchant computer program. At an end of the session: the merchant computer program may be configured to aggregate the transactions that were authorized by the issuer computer program; to submit the aggregated transactions to the issuer computer program for payment; and the issuer computer program may be configured to initiate payment for the aggregated transactions.

In one embodiment, the merchant computer program may be further configured to receive a transaction limit from the customer and to apply the transaction limit to each transaction before authorizing the transaction with the issuer computer program. The transaction limit may be a maximum number of transactions during the session, a maximum dollar amount for each transaction during the session, a maximum total dollar amount for all transactions during the session, etc.

In one embodiment, the merchant computer program may be further configured to receive a session duration from the customer, and to end the session at completion of the session duration.

In one embodiment, the merchant computer program further may be configured to periodically receive a location of the customer electronic device, and to end the session in response to the location of the customer electronic device being outside of a merchant location.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for conversational transacting according to an embodiment;

FIG. 2 illustrates a method for conversational transacting according to an embodiment; and

FIG. 3 depicts an exemplary computing system for implementing aspects of the present disclosure.

### DETAILED DESCRIPTION OF PREFERRED EMBODIMENTS

Systems and methods for conversational transacting are disclosed.

The disclosure of U.S. Provisional Patent Application Ser. No. 62/487,025, filed Apr. 19, 2017, and U.S. patent application Ser. No. 15/957,331, now U.S. Pat. No. 11,507,954, are hereby incorporated, by reference, in their entireties.

A typical transaction conducted as a single message or dual messages may include a message about the transaction being authorized/cleared and then settled. Conversational transacting allows a merchant to obtain a unique Transaction Identifier (ID) and then issue single message commands to authorize and reverse amounts multiple times before a given transaction is completed. This may be done for card present or a card not present transactions. All card functions may be supported, including authorizations, returns, reversals, etc. In one embodiment, the merchant may associate a session identifier to the customer's card number and may use that session identifier for all transactions.

The individual transactions may be completed after a certain amount of time has passed (e.g., 10 minutes, 1 hour, 4 hours, etc.), when the merchant closes operations for the day, when the customer leaves the premises (e.g., leaves a park, restaurant, etc.), etc. The merchant and/or the customer may set preferences for when the individual transactions are completed.

For example, the user may use an electronic device to electronically present a financial instrument to a merchant when entering an area (e.g., a park, a venue, a bar, etc.), and when the customer leaves the area, all individual transactions may be completed. The location of the customer's electronic device may be used to determine the customer's location.

The consolidation of the individual transactions may be used to optimize the transactions, which may lead to reduced transaction fees.

Illustrations of conversational transactions are provided below:
(start session←ID) (authorize ID, w/PIN $100, “dinner”) (authorize ID, wo/PIN $10, “tip”) (authorize ID, w/PIN, “bar”) (end session→ID
(start session←ID) (authorize ID, w/PIN $520, “purchase”) (authorize ID, Points, $50, “purchase”) (end session→ID)

In one embodiment, each individual transaction may be labeled with a transaction description, merchant description, amount, SKU and/or other relevant information. The information may be provided in a JSON object or similar.

In one embodiment, the customer may be provided with the conversation view of the transaction in the customer's statement, online, and in other channels. This may provide a better illustration of the transactions for a period of time, with a certain merchant, etc.

Individual transactions may or may not require that the user enter a PIN. For example, the merchant may require entry of the PIN for the first individual transaction, when the transaction exceeds a certain amount, when a certain period of time has passed between transactions, etc.

In one embodiment, merchants that authorize for one value then reverse that and split a transaction into multiple transactions as items are shipped may provide a clean view of the individual transactions in the transaction history.

In one embodiment, an acquirer may provide the conversational transacting service for its merchants. For example, the merchant may submit individual transactions to the acquirer, and the acquirer may convert the individual transactions into a group of transactions for the merchant.

In one embodiment, the messaging scheme may also be used as a ticketing process. For example, once the merchant or the event provider has a session ID, the customer's card may be presented in order to gain access to event areas, certain restricted areas within a venue, etc.

In embodiments, conversational transacting may assume completion of individual transactions. For example, today, with credit card processing, the authorization falls off after a certain number of days if the clearing is not received to confirm the purchase. In a single message scheme, the issuer may set an assumed timeframe to self-inject a clearing indicator after a period of time (e.g., instantly, seconds, hours, days, etc.) unless a cancel transaction is received from the merchant. This keeps issuer processing consistent internally, but allows for merchants and/or acquirers to reduce the number of messages sent.

Embodiments may provide real-time posting and/or real-time funding. For example, a merchant may send a transaction authorization and, if the transaction authorization is approved, funds may be moved directly to the merchant's account. This may be done using, for example, a real time transfer, FedNow, Zelle, etc. for transferring funds. Instant processing may be performed in reverse, allowing for reversals, refunds and disputes processing to move money instantly.

In one embodiment, merchants may be required to keep a minimum amount in the merchant's transfer account based on the merchant's usage, or an acquirer may pool funds across multiple merchants, etc. In one embodiment, the issuer or the acquirer may extend credit to merchants to cover the transfers.

In embodiment, a Card Verification Value 2 (CVV2) may be injected into an online transaction. For example, when processing a credit card transaction online, the PIN field may be populated with the provided CVV2 value from the customer. The CVV2 may be used to build the PIN block for the online transaction.

In embodiments, a surrogate PIN may be used for transactions, including wallet, swipe, tap, or dip transactions involving a physical credit card. For example, the merchant or acquirer may inject a PIN block to enable routing over a PIN network (e.g., a debit network) using a PIN generation scheme, such as using the expiration date as the PIN, hashing certain fields with an optional SALT, taking the first or 6 last digits of the card number as the PIN, etc.

Embodiments may convert a transaction from an offline (e.g., non-PIN) transaction to an online (e.g., PIN) transaction. Traditionally, if a PIN is not entered, a transaction is an offline transaction and runs on dual message rails. In embodiments, a merchant point of transaction device may interact with a customer's financial institution (i.e., the card issuer) application via Bluetooth Low Energy (BLE), ultrawideband (UWB), etc. to retrieve a surrogate PIN from the financial institution application for a transaction. The surrogate PIN may also be communicated by the financial institution application to the financial institution backend for matching.

Geofencing may also be used to confirm that the customer is near the point of transaction device, thereby increasing confidence in the transaction.

In embodiments, the customer's electronic device may be used as a stand-in or even primary authorization device. For example, a merchant point of transaction device may use BLE, UWB, the merchant's Wi-Fi network, or other technology with a public key to broadcast a one-way hash of the card number and expiration date along with the transaction amount and other data about the merchant and goods being sold. Electronic devices in range with the financial institution's (i.e., the card issuer) application may receive this and validate the transaction using the same public key the information received (e.g., the hash stored or generated on device).

The electronic device, using the financial institution application, may reply with a reversed hash of the customer's credit card (e.g., expiration date and card number) to the point of transaction with an approval, a decline, a maximum amount, etc. that may be based on cached issuer data on the electronic device. The point of transaction may validate this reversed hash to ensure that it was from the customer's electronic device, and may execute the transaction based on the response.

When tapping and paying with a mobile wallet, the spend limit for an approval may also be sent to the point of transaction, thereby eliminating the need to authorize through the network. This may be combined with the use of BLE, UWB, and WiFi, above, to verify with the financial institution application that the wallet data is valid.

Embodiments may also provide dynamic conversion from a single to dual messages. Acquirers generally manage the conversion from SMS to DMS. Moving that conversion into the network layer provides additional consistency allowing for both PIN and PIN-less single message transactions to be converted into dual message, while at the same time keeping the benefits of single message, such as allowing for instant/near instant funding of the transaction. The determination of when to convert the message may be made using a machine learning engine that is trained on historical transactions. For example, transactions that are determined to not have a difference in the final value (e.g., no tips) may be converted to dual message in near real-time with the clearing being sent to the issuer. For transactions where a change in the final value may occur, embodiments may wait a period of time (e.g., hours or days) based on past transaction behavior, and then the clearing message may be delivered to the issuer. This allows the issuer systems to remain consistent with limited if any, changes while still supporting merchant/acquirer flexibility in message format.

Note that this may not be a backup source of funding, but instead a modification of the transaction.

Embodiments may provide a distributed payment network. For example, the payment network may be provided on the merchant premises. A device or application (in a container) may be provided, or a Software as a Service (SaaS) model may be used where the merchant may host the payment network locally within its system. The issuer, payment network, and/or the point of sale device may publish real-time encrypted data into the device or containerized application to support localized network processing. This may reduce latency and provide greater flexibility to larger merchants.

The disclosures of U.S. Provisional Patent Application Ser. No. 62/680,674 and U.S. patent application Ser. No. 16/432,623 are hereby incorporated, by reference, in their entireties.

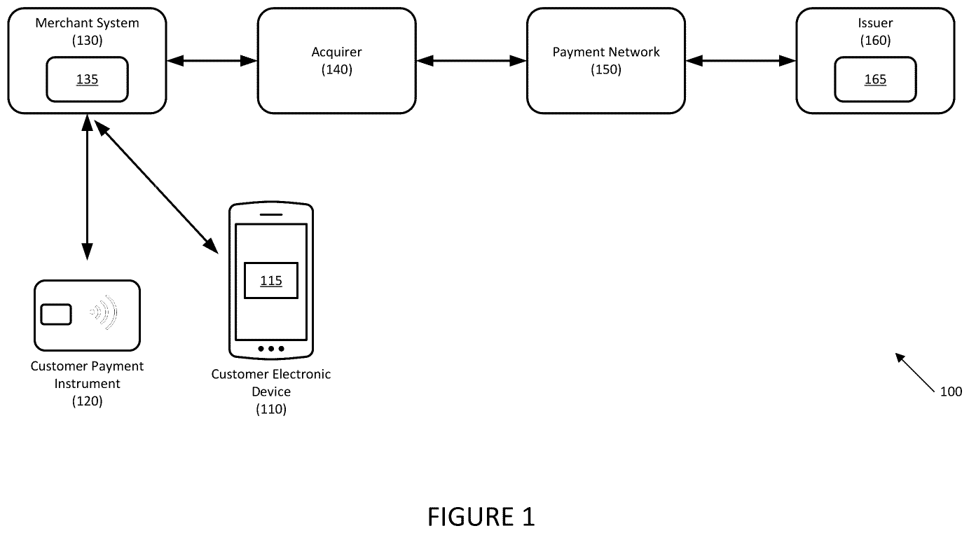

Referring to FIG. 1, a system for conversational transacting is disclosed according to an embodiment. System 100 may include customer electronic device 110, which may be a mobile electronic device such as a computer (e.g., laptop, notebook, tablet, etc.), a smart device (e.g., smartphone, smart watch, etc.), an Internet of Things (IoT) appliance, etc. Customer electronic device 110 may execute application 115, such as an electronic wallet application, a payment application, an issuer application, etc. Application 115 may communicate payment information, such as a payment token, for customer payment instrument 120, such as a credit card, a debit card, etc.

A customer may present customer electronic device 110, or customer payment instrument 120, to merchant system 130 at the beginning of a session that may include a plurality of individual transactions. In one embodiment, merchant system 130, which may be a point-of-sale device, may receive payment instrument information from application 115 (e.g., a payment token) or from customer payment instrument 120 by near field communication (NFC), swiping, dipping, etc.

Merchant system 130 may execute merchant computer program 135.

System 100 may further include acquirer 140, payment network 150, and issuer 160. Acquirer 140 may receive a transaction authorization request from merchant system 130 and route the transaction authorization request to payment network 150. Payment network 150 may identify issuer 160 and may route the transaction authorization request to issuer 160, which may include an issuer backend. Using issuer computer program 165, issuer 160 may perform fraud and authorization checks on the transaction authorization request, and may return a decision (approval or deny) to merchant system 130 via payment network 150 and acquirer 140.

In one embodiment, merchant system 130 may store information for the customer payment instrument 120 or the payment token received from application 115 during a session. For example, a session may start when the customer provides customer payment instrument 120 or the payment token to merchant system 130, and may end when the customer leaves an area (e.g., leaves a geofence), instructs merchant system 130 to end the session, at the end of a session duration (e.g., a predetermined amount of time, an ending time, etc. which may be set by the customer, by the merchant, by issuer 160, etc.), etc. In one embodiment, the customer may communicate the end of the session to merchant 130 using application 115. In another embodiment, the customer may communicate the end of the session to issuer 160, which may then communicate the end of the session to merchant 130 via payment network 150 and acquirer 140, or may simply reject any further transactions from merchant system 130.

In one embodiment, issuer 160 may perform an authorization check and/or a fraud check for each transaction as the customer presents a transaction to merchant system 130.

In one embodiment, application 115 may be an application associated with issuer 160, and may provide the location of customer electronic device 110 to issuer 160. This may increase issuer 160's trust in the customer, customer electronic device 110, etc. and may increase the ability to perform offline spending using customer electronic device 110.

In another embodiment, the presence of customer electronic device 110 at a branch location for issuer 160 may also increase the ability to perform offline spending using customer electronic device 110.

In one embodiment, customer electronic device 110 may periodically provide its location (e.g., a Global Positioning Service location) to merchant system 130. When merchant system 130 determines that the location for customer electronic device 110 is no longer at the merchant location, merchant system 130 may end the session.

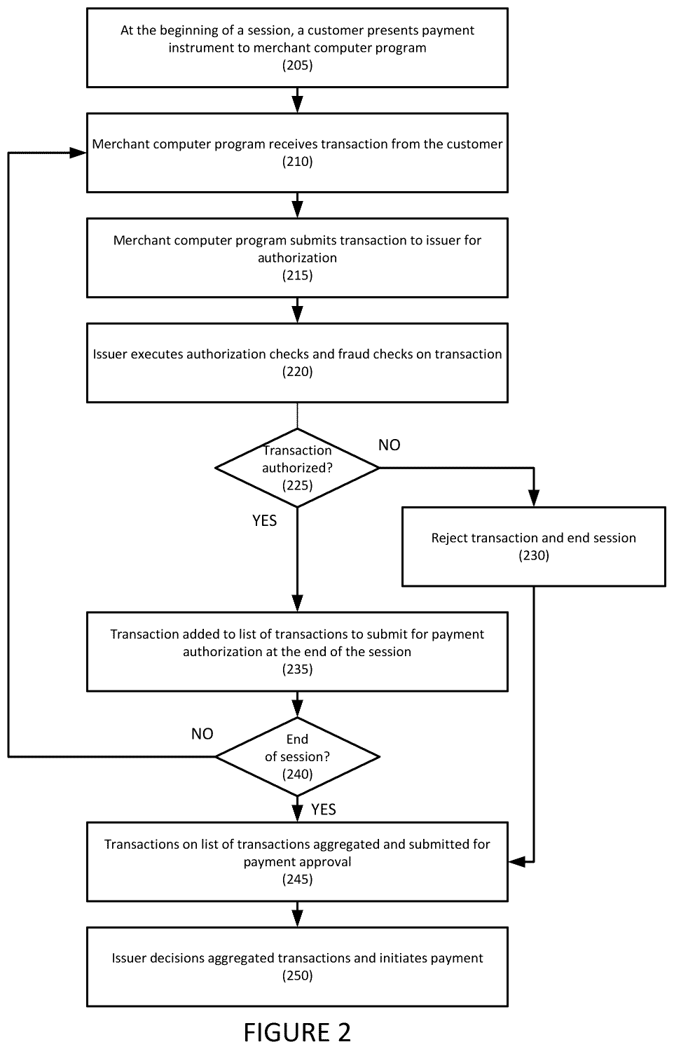

Referring to FIG. 2, a method for conversational transacting is disclosed according to an embodiment.

In step 205, at the beginning of a session in which a customer may anticipate making a plurality of transactions, the customer may present a payment instrument to a merchant computer program executed by a merchant system. For example, the customer may present a payment instrument by presenting a physical payment instrument to a point-of-sale device by swiping, tapping, or dipping, or may communicate a payment token for the payment instrument through an application, such as a payment application, executed on the customer's electronic device.

In one embodiment, the customer may present the customer's PIN to the merchant computer program.

In one embodiment, the customer may provide an instruction to start the session, and may also provide any restrictions or limitations on the session. For example, the customer may set a limit on the number of transactions that may occur during the session, may set a dollar limit on each transaction or on the aggregated transactions, may set duration or end time for the session (e.g., 10 minutes, 1 hour, 4 hours, a specific end time, etc.), etc. Any suitable restriction may be used as necessary and/or desired.

In one embodiment, preauthorization may be performed. For example, before a session is started, by the issuer may push rules to the merchant computer program that may prevent the session due to risk or other factors, may provide a spending limit (individual transactions or total amount), etc.

In one embodiment, the merchant computer program may initiate the session and may provide session identifier for the session that may be used to identify the customer. For example, the customer may be identified using, for example, a one-way hash of the token for the customer's credit card (e.g., a digital primary account number). In another embodiment, the customer identifier may be a hash of a session identifier from an application, such as an issuer application. executed by the customer's electronic device.

In one embodiment, a location identifier for the merchant may be used as a cryptographic SALT to allow for multi-session processing without conflict.

In step 210, once the session has started, the merchant computer program may receive a transaction from the customer.

In one embodiment, the customer may be required to provide the customer's PIN. The PIN may be required for every transaction, for transactions above a certain amount, when a certain amount of time has passed since the last transaction, etc.

In step 215, the merchant computer program may submit the transaction to issuer for authorization as a transaction authorization request. In one embodiment, the session hash may be included with each transaction. In one embodiment, before submitting the transaction to the issuer, the merchant computer program may apply any limits on the transaction. If the transaction is not compliant with the limits, the transaction may be rejected.

In one embodiment, the issuer may also apply limits based on spending, fraud, etc.

In step 220, the issuer may receive the transaction from the merchant computer program via an acquirer and a payment network, and may perform authorization checks and fraud checks on the transaction.

In one embodiment, the checks may be standard checks, but may also include location validation, session validation, etc.

In one embodiment, authorization may occur after the session is complete. Optionally, the transactions may be force-posted.

If, in step 225, the transaction is not authorized, in step 230, the issuer may reject the transaction and end the session.

If, in step 225, the transaction is authorized, in step 235, the transaction may be added to a list of transactions to submit for payment authorization at the end of the session. Alternatively, the transactions may be force-posted.

In step 240, a check may be made to determine if the session has ended, such as if a limit on a number of transactions or an aggregated transaction amount has been reached, if a time limit has been reached, if the customer has left the area, if the customer has instructed the merchant computer program or the issuer to end the session, etc. If the session is not ended, the process may return to step 210.

For example, the customer electronic device 110 may periodically provide its location (e.g., a Global Positioning Service location) to the merchant computer program, and the merchant computer program may end the session when the merchant computer program determines that the location for the customer electronic device is no longer at the merchant location.

If the session has ended, in step 245, the merchant computer program may aggregate the transactions on the list of transactions, and may send the aggregated transaction to the issuer for authorization. The aggregated transactions may be provided with the hash of the session identifier.

In step 250, the issuer may optionally decision the aggregated transaction, and may initiate payment for the aggregated transactions.

Embodiments may be directed to a using a PIN that is shared among multiple financial instruments. Many credit card cardholders do not know their credit card PINs, as credit card PINs are normally only used for cash withdrawals. In embodiments, credit card processing may be run over a single message PIN network by associating the customer's debit card PIN directly (customer chosen) or indirectly (Issuer determined) with the customer's credit card. The debit card and the credit card may be issued by the same issuer, or there may be a consortium process that supports sharing this data securely.

For example, the customer's credit card may be processed using, for example, the customer's PIN. The customer may be prompted for the PIN by the point of sale device and may be given an opportunity to use a credit card account or a debit card account for the transaction. An example of such is the use of a surrogate PIN, disclosed in U.S. Pat. No. 11,507,954, the disclosure of which is hereby incorporated, by reference, in its entirety.

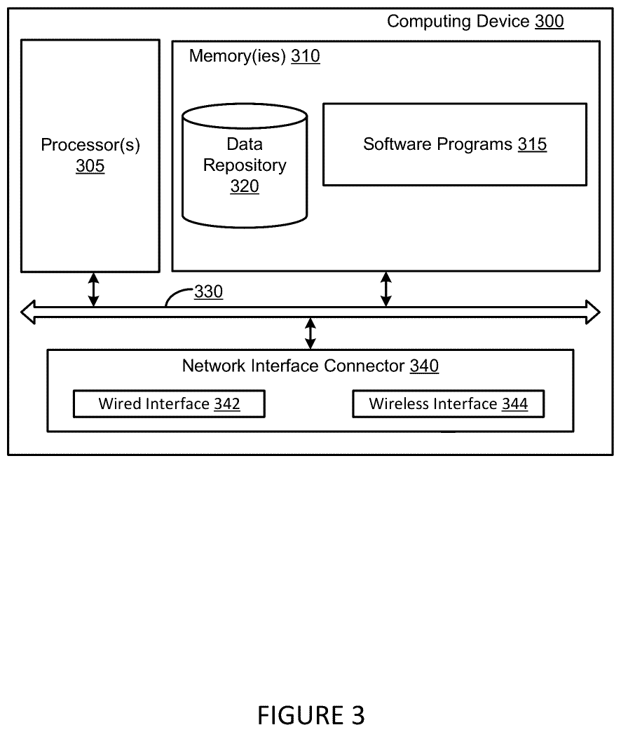

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a merchant computer program, a payment instrument from a customer;
initiating, by the merchant computer program, a session with the customer by providing a session identifier for the session to a customer electronic device;
during the session:
receiving, by the merchant computer program, a plurality of transactions from the customer, each with the session identifier; and
authorizing, by the merchant computer program, each of the plurality of transactions with an issuer of the payment instrument;
at an end of the session:
aggregating, by the merchant computer program, the transactions that were authorized by the issuer; and
submitting, by the merchant computer program, the aggregated transactions to the issuer for payment.

2. The method of claim 1, further comprising:
receiving, by the merchant computer program, a customer PIN with the payment instrument;
wherein the merchant computer program authorizes one of the transactions with the issuer of the payment instrument using the customer PIN.

3. The method of claim 1, further comprising:
receiving, by the merchant computer program, a transaction limit from the customer; and
applying, by the merchant computer program, the transaction limit to each transaction before authorizing the transaction with the issuer.

4. The method of claim 3, wherein the transaction limit is a maximum number of transactions during the session.

5. The method of claim 3, wherein the transaction limit is a maximum dollar amount for each transaction during the session.

6. The method of claim 3, wherein the transaction limit is a maximum total dollar amount for all transactions during the session.

7. The method of claim 1, further comprising:
receiving, by the merchant computer program, a session duration from the customer, and
ending, by the merchant computer program, the session at completion of the session duration.

8. The method of claim 1, further comprising:
receiving, by the merchant computer program, rules from the issuer; and
applying, by the merchant computer program, the rules to each transaction before authorizing each transaction with the issuer.

9. The method of claim 1, further comprising:
periodically receiving, by the merchant computer program, a location of the customer electronic device; and
ending, by the merchant computer program, the session in response to the location of the customer electronic device being outside of a merchant location.

10. A non-transitory computer readable storage medium, including instructions stored thereon, which when read and executed by one or more computer processors, cause the one or more computer processors to perform steps comprising:
receiving a payment instrument from a customer;
initiating a session with the customer by providing a session identifier for the session to a customer electronic device;
during the session:
receiving a plurality of transactions from the customer, each with the session identifier; and
authorizing each of the plurality of transactions with an issuer of the payment instrument; and
at an end of the session:
aggregating the transactions that were authorized by the issuer; and
submitting the aggregated transactions to the issuer for payment.

11. The non-transitory computer readable storage medium of claim 10, further including instructions stored thereon, which when read and executed by the one or more computer processors, cause the one or more computer processors to perform steps comprising:
receiving a customer PIN with the payment instrument; and
authorizing one of the transactions with the issuer of the payment instrument using the customer PIN.

12. The non-transitory computer readable storage medium of claim 10, further including instructions stored thereon, which when read and executed by the one or more computer processors, cause the one or more computer processors to perform steps comprising:
receiving a transaction limit from the customer; and
applying the transaction limit to each transaction before authorizing the transaction with the issuer.

13. The non-transitory computer readable storage medium of claim 12, wherein the transaction limit is a maximum number of transactions during the session, a maximum dollar amount for each transaction during the session, or a maximum total dollar amount for all transactions during the session.

14. The non-transitory computer readable storage medium of claim 10, further including instructions stored thereon, which when read and executed by the one or more computer processors, cause the one or more computer processors to perform steps comprising:
receiving a session duration from the customer, and
ending the session at a completion of the session duration.

15. The non-transitory computer readable storage medium of claim 10, further including instructions stored thereon, which when read and executed by the one or more computer processors, cause the one or more computer processors to perform steps comprising:
receiving rules from the issuer; and
applying the rules to each transaction before authorizing the transaction with the issuer.

16. The non-transitory computer readable storage medium of claim 10, further including instructions stored thereon, which when read and executed by the one or more computer processors, cause the one or more computer processors to perform steps comprising:
periodically receiving a location of the customer electronic device; and
ending the session in response to the location of the customer electronic device being outside of a merchant location.

17. A system, comprising:
a customer electronic device associated with a customer;
a merchant system executing a merchant computer program; and
an issuer electronic device executing an issuer computer program;
wherein:
the merchant computer program is configured to receive a payment instrument from the customer;
the merchant computer program is configured to initiate a session with the customer by providing a session identifier for the session to the customer electronic device;
the merchant computer program is configured to receive rules from the issuer computer program;
during the session:
the merchant computer program is configured to receive a plurality of transactions from the customer, each with the session identifier;
the merchant computer program is configured to apply the rules to each of the plurality of transactions;
the merchant computer program is configured to authorize each of the plurality of transactions with the issuer computer program in response to the transaction passing the rules; and
the issuer computer program is configured to authorize each of the transactions and to return an authorization decision to the merchant computer program;
at an end of the session:
the merchant computer program is configured to aggregate the transactions that were authorized by the issuer computer program;
the merchant computer program is configured to submit the aggregated transactions to the issuer computer program for payment; and
the issuer computer program is configured to initiate payment for the aggregated transactions.

18. The system of claim 17, the merchant computer program is further configured to receive a transaction limit from the customer and to apply the transaction limit to each transaction before authorizing the transaction with the issuer computer program;
wherein the transaction limit is a maximum number of transactions during the session, a maximum dollar amount for each transaction during the session, or a maximum total dollar amount for all transactions during the session.

19. The system of claim 17, wherein:
the merchant computer program is further configured to receive a session duration from the customer, and to end the session at completion of the session duration.

20. The system of claim 17 wherein:
the merchant computer program further is configured to periodically receive a location of the customer electronic device, and to end the session in response to the location of the customer electronic device being outside of a merchant location.
